(19) United States
(12) Patent Application Publication
(10) Pub. No.: US 2014/0040258 A1
(43) Pub. Date: Feb. 6, 2014

(54) CONTENT ASSOCIATION BASED ON TRIGGERING PARAMETERS AND ASSOCIATED TRIGGERING CONDITIONS

(71) Applicant: NOVELSONG INDUSTRIES LLC, Atlanta, GA (US)

(72) Inventors: Joshua G. Schwartz, Atlanta, GA (US); Kenneth J. Green, Atlanta, GA (US); Charles Dasher, Lawrenceville, GA (US); James Angelo Aparo, Atlanta, GA (US)

(73) Assignee: NOVELSONG INDUSTRIES LLC, Atlanta, GA (US)

(21) Appl. No.: 13/844,311

(22) Filed: Mar. 15, 2013

Related U.S. Application Data
(60) Provisional application No. 61/677,988, filed on Jul. 31, 2012.

(51) Int. Cl. G06F 17/30

(52) U.S. Cl. CPC G06F 17/30058
USPC 707/736

(57) ABSTRACT

Systems, methods, and computer-readable media for associating content are disclosed. First content, such as video content or audio content, may be associated with second content, such as text, images, audio content, or video content, using content association data. The content association data may include triggering information that specifies one or more triggering parameters and one or more associated triggering conditions. Upon satisfaction of at least one of the triggering condition(s) associated with a corresponding at least one triggering parameter, the second content associated with the at least one triggering parameter may be presented to a user, for example, during playback of the first content. Further, one or more identifiers determined to be associated with a geographical location associated with a user device may be used to identify related content for presentation to a user of the user device. In addition, content may be identified and presented to a user based on one or more user interactions with other content.

### CROSS-REFERENCE TO RELATED APPLICATION

This application is a non-provisional of U.S. Provisional Application No. 61/677,988, filed on Jul. 31, 2012, and entitled “Content Association Based on Triggering Parameters and Associated Triggering Conditions,” the disclosure of which is incorporated by reference herein in its entirety.

### TECHNICAL FIELD

This disclosure relates generally to content association, and more specifically, to content association based on various triggering parameters and associated triggering conditions.

### BACKGROUND

Various multimedia content services have become more popular as digital technologies have developed to accommodate higher data transfer rates. These multimedia content services may provide multimedia content to users including audio content, still images, animation, video content, interactive content, or any combination thereof. Multimedia content may be generated, recorded, or stored, as well as played, displayed, or accessed, by various electronic devices such as desktop computers, laptop computers, smartphones, tablet devices, and so forth. Multimedia content may be provided through online streaming services or download services. For example, multimedia content may be accessed and played via various web-based players or, alternatively, may be played in connection with software applications installed on user devices.

### SUMMARY

Embodiments of the disclosure relate to systems, methods, and computer-readable media for associating content so that at least a portion of the content may be accessed and presented to a user based on the occurrence of one or more triggering conditions associated with one or more triggering parameters. The triggering conditions may specify one or more characteristics associated with corresponding triggering parameters that, when present, may trigger the access and/or presentation of associated content. Embodiments of the disclosure also relate to identifying content associated with a geographical location and accessing and presenting the content to a user device when the device is associated with the geographical location. Further embodiments of the disclosure relate to identifying content associated with one or more user interactions with other content, and accessing and presenting the content to a user upon receipt of information relating to the one or more user interactions.

In one or more embodiments of the disclosure, first content may be identified. The first content may include audio content, video content, or any other content. Triggering information that specifies one or more triggering parameters and one or more associated triggering conditions may be received. Information identifying second content may also be received. The second content may include text, images, audio content, video content, scripted code, or any other content. The first content may be associated with the second content based at least in part on the triggering information. Content association data may be generated that associates the second content with the first content. The content association data may include the triggering information. If it is determined that a particular triggering condition is satisfied with respect to a particular triggering parameter, for example, during presentation of the first content, at least a portion of the second content that is associated with the triggering parameter may be presented in association with the first content.

The triggering parameter(s) may include one or more temporal parameters such as a trigger time point, a trigger time segment, a time/date stamp, and so forth. Triggering conditions associated with temporal triggering parameters may include the occurrence of a particular trigger time point or trigger time segment during playback of content. The triggering parameter(s) may further include any one or more of: one or more characteristics associated with content different from the first content or the second content, contextual information, one or more characteristics associated with a user device, one or more audible elements, one or more video elements, one or more frequency elements, a user input received from a user device, one or more interactions between the user and the first content or the second content, a geographical location associated with the user, or a geographical location associated with the user's device. The triggering parameter(s) may further include metadata associated with the first content. The metadata may include any one or more of: a track listing, a song title, an album title, a track number, one or more tags associated with the first content, an audio fingerprint, a video fingerprint, and so forth.

In one or more additional embodiments of the disclosure, first content may be identified and transmitted for presentation to a user via a user device. Content association data that associates the first content with second content may also be identified. The content association data may include triggering information that includes information relating to one or more triggering parameters and one or more associated triggering conditions. A determination may be made as to whether at least one triggering condition associated with a corresponding at least one triggering parameter is satisfied. The at least one triggering condition may be satisfied when one or more characteristics associated with the first content or presentation of the first content are present. Satisfaction of the at least one triggering condition may cause at least a portion of the second content that corresponds to the at least one triggering parameter to be accessed and transmitted for presentation to the user.

In one or more additional embodiments of the disclosure, a geographical location associated with a user device may be identified. One or more identifiers associated with the geographical location may be determined, and content may be identified based at least in part on the one or more identifiers associated with the geographical location. The content may be identified by determining that one or more information elements associated with the content correspond to at least one of the one or more identifiers associated with the geographical location.

In one or more additional embodiments, first content may be transmitted for presentation to a user, one or more inputs associated with one or more interactions of the user with the first content may be received, and second content associated with the first content may be identified based at least in part on the one or more user interactions. Once identified, the second content may be transmitted for presentation to the user.

Various embodiments of the disclosure may be implemented by one or more computer processors executing computer-executable instructions stored on a machine-readable medium. In yet further examples, systems, subsystems or devices may be adapted to provide functionality associated with various embodiments of the disclosure. These and other features, examples, and embodiments of the disclosure are described in more detail below in the detailed description that follows through reference to the accompanying drawings.

### BRIEF DESCRIPTION OF THE DRAWINGS

Embodiments are illustrated by way of example, and not limitation, in the figures of the accompanying drawings, in which like references indicate similar elements, and in which:

FIG. 1 depicts a simplified block diagram of an illustrative system architecture for content creation and/or association in accordance with one or more embodiments of the disclosure.

FIG. 2 depicts a simplified block diagram of an illustrative content creation/association system architecture in accordance with one or more embodiments of the disclosure.

FIG. 3 depicts a process flow diagram illustrating an example method for associating first content with second content in accordance with one or more embodiments of the disclosure.

FIG. 4 depicts a simplified representation of an audio recording illustrating various time triggers and content associated with the time triggers in accordance with one or more embodiments of the disclosure.

FIG. 5 depicts a simplified block diagram of an illustrative content presentation system architecture in accordance with one or more embodiments of the disclosure.

FIG. 6 depicts a process flow diagram illustrating an example method for presenting content based on the occurrence of one or more triggering conditions in accordance with one or more embodiments of the disclosure.

FIG. 7 depicts a process flow diagram illustrating another example method for presenting content based on an identified geographical location in accordance with one or more embodiments of the disclosure.

FIG. 8 depicts a process flow diagram illustrating another example method for presenting content based on one or more user interactions.

FIG. 9 depicts an illustrative graphical user interface for associating various content in accordance with one or more embodiments of the disclosure.

FIG. 10 depicts an illustrative graphical user interface for presenting content in accordance with one or more embodiments of the disclosure.

FIG. 11 depicts a diagrammatic representation of an illustrative machine in the form of a computer system for performing any one or more of the methodologies discussed herein in accordance with one or more embodiments of the disclosure.

### DETAILED DESCRIPTION

The following detailed description includes references to the accompanying drawings, which form part of the detailed description. The drawings depict illustrations in accordance with example embodiments. These example embodiments, which are also referred to herein as “examples,” are described in enough detail to enable those skilled in the art to practice the claimed subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computer system or in hardware utilizing either a combination of microprocessors, or other specially designed application-specific integrated circuits (ASICs), programmable logic devices, or various combinations thereof. In particular, the methods described herein may be implemented by a series of computer-executable instructions stored on a storage medium such as a disk drive or a computer-readable medium of any kind.

According to one or more example embodiments of the disclosure, systems, methods, and computer-readable media are disclosed for associating first content with second content such that during presentation (e.g., playback, display, etc.) of the first content, the second content may be optionally accessed and presented based on the occurrence of one or more events satisfying one or more triggering conditions associated with corresponding triggering parameter(s). Content association data may be generated that associates the first content with the second content. The content association data may include triggering information that comprises the triggering parameter(s) and the associated triggering conditions. The content association data may be integrated into the first content, stored as a separate, standalone metadata file, or stored at a location that is different from where the first content and/or the second content is stored and may be accessed when desired.

In a specific, non-limiting example, the triggering parameters may include temporal parameters such as timing triggers. Examples of timing triggers may include a trigger time point or a trigger time segment. The associated triggering conditions may be satisfied when a specific point in time or segment of time that corresponds to the temporal triggering parameters is reached during presentation (e.g., playback) of the first content, which may cause the second content to be accessed and presented in association with the first content. In various embodiments, presentation of the first content may be halted, at least temporarily, during presentation of the second content, and may be resumed subsequent to or during presentation of the second content. In other embodiments, the second content may be presented simultaneously with presentation of the first content.

In other embodiments, the triggering information may specify other types of triggering parameters such as various audio characteristics (e.g., decibel levels, frequency levels, spectrum, etc.), various video characteristics (e.g., grayscale levels, contrast levels, brightness levels, etc.), audio or video fingerprints, user input(s) associated with various user interaction(s) (e.g., a user gesture, a mouse click, a touch-screen input, etc.), contextual information (e.g., other content in connection with which the first content and/or the second content is presented, thematic elements associated with the first content and/or the second content, etc.), geographical information (e.g., various identifiers associated with a geographical location of a user's device), metadata associated with the first content and/or the second content (e.g., a track number or title, a song/video title, other tags associated with content and providing information with respect thereto, etc.), and so forth. It should be understood that the above exemplary list of triggering parameters is not exhaustive and that any number/types of triggering parameters may be provided. It should further be appreciated that triggering parameters and associated triggering conditions may be specified in any number of ways to cause any number or type of associations between the first content and the second content (and optionally other content).

In an example embodiment of the disclosure, a software application or online platform may be provided for various content, enabling users to identify and/or provide desired content to be associated. For example, in one or more example embodiments, users may be provided with the capability to select desired content via a digital library accessible via the same platform. Users may associate multimedia content with other content by, for example, generating content association data that associates the various content based on triggering parameters and various associated triggering conditions, thereby providing a new content experience for the user. As an example, the approaches disclosed herein may be a valuable extension for existing video or audio content and may provide a unique experience for listening to music or watching video content. While many songs or movies may be found on the Internet free of charge, the content association data and/or the associated multimedia content may be protected from illegal copying and/or distribution via the Internet. As such, the content association data may be user-centered and/or encrypted such that the content association data cannot be easily accessed by third parties. In addition, or alternatively, the content association data may be accessed via a dedicated web platform or software application. Accordingly, content providers may be provided with an alternative revenue source that provides suitable protection for their proprietary content.

One or more additional embodiments of the disclosure are directed to systems, methods, and computer-readable media for presenting associated content to a user. In one or more specific embodiments, presentation of second content that is linked to first content is enabled in connection with presentation of the first content. A web platform or software application may be provided, which may include a player that enables accessing various content and related content association data stored on, for example, one or more remote servers.

One or more other example embodiments of the disclosure relate to systems, methods, and computer-readable media for identifying content based on a geographical location associated with a user device and presenting an indication of the identified content to a user of the user device. The geographical location associated with the user device may be determined using, for example, a global positioning system (GPS) receiver, a cellular network, the Internet, or any other suitable system. Once the geographical location associated with the user device is determined, one or more identifiers associated with the geographical location may be determined. A non-exhaustive list of the identifiers associated with the geographical location may include one or more names associated with the geographical location, information relating to one or more landmarks associated with the geographical location, information relating to one or more historical events associated with the geographical location, and so forth. Content may then be identified based on a correspondence between one or more information elements associated with the content and at least one of the one or more identifiers associated with the identified geographical location. The information element(s) may include, for example, metadata tags associated with the content. An indication of the identified content and access thereto may then be provided to the user.

One or more additional example embodiments of the disclosure relate to the presentation of content to a user based on one or more user inputs. For example, a user may be presented with first content via a user device. The user may be provided with the capability to interact with the first content in various ways (e.g., touch gestures, mouse clicks, touch-screen interactions, etc.). User input(s) corresponding to the user interactions may be detected, and second content associated with the first content may be accessed and/or presented to the user via the user device based on the detected user input(s). The second content may be accessed based on content association data that specifies a correspondence between various user interactions and the corresponding second content that is accessed upon detection of user input(s) that correspond to the user interactions. The user input(s) may represent triggering conditions that trigger the access and presentation of the second content. The second content may be provided to the user concurrently with the first content or in any suitable manner.

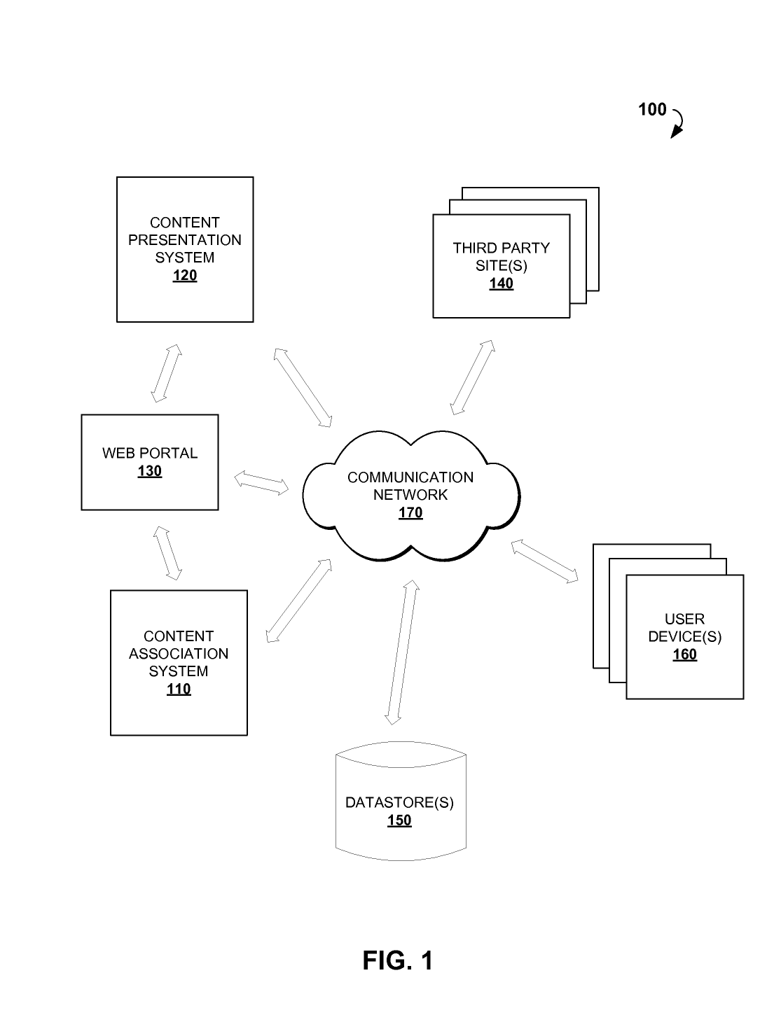

FIG. 1 depicts a block diagram of an illustrative system architecture 100 for associating and/or presenting content in accordance with one or more embodiments of the disclosure. In particular, the system architecture 100 includes a content association system 110, a content presentation system 120, a web portal 130, one or more third party sites 140, one or more datastore(s) 150, one or more user devices 160, and one or more communication network(s) 170.

The content association system 110 may be configured to provide functionality for associating various content (e.g., associating first content with second content (and optionally other contents)). The content association system 110 may be implemented as computer codes, software, firmware, hardware, or any combination thereof. In various illustrative embodiments, the content association system 110 may include one or more servers (e.g., a server farm) that may be accessed by the user device(s) 160 via the communication network(s) 170. In various embodiments, the functionality of the content association system 110 may be provided to the web portal 130 or the third party sites 140. In other embodiments, the content association system 110 may be implemented as a software application (not shown) that may be installed on one or more of the user device(s) 160. In further embodiments, the content association system 110 may correspond to one or more remote servers, and software application(s) installed on the user device(s) 160 may be provided for communicating with the content association system 110 via the communication network(s) 170. The software application(s) may communicate with the content association system 110 according to, for example, a client-server model.

The content presentation system 120 may provide functionality for presenting or providing access to content such as various associated content that has been associated using the content association system 110. The content presentation system 120 may be implemented as computer codes, software, firmware, hardware, or any combination thereof. In various illustrative embodiments, the content presentation system 120 may include one or more servers (e.g., a server farm) that may be accessible by the user device(s) 160 via the communication network(s) 170. In various embodiments, the functionality associated with the content presentation system 120 may be provided to the web portal 130 or the third party site(s) 140. In other embodiments, the content presentation system 120 may be implemented as a software application (not shown) and may be installed on one or more of the user device(s) 160. In further embodiments, the content presentation system 120 may correspond to one or more servers, and software application(s) installed on the user device(s) 160 may be provided for communicating with the content presentation system 120 via the communication network(s) 170. The software application(s) may communicate with the content presentation system 120 according to, for example, a client-server model.

The web portal 130 may comprise one or more web pages or websites that provide functionality for generating associations between various content according to various methodologies disclosed herein. The web portal 130 may also provide functionality for presenting content. In various embodiments, the web portal 130 may provide access to multiple digital libraries or digital stores storing multimedia content for purchase or for use free of charge. Further, the web portal 130 may serve as a platform for sharing or distributing various multimedia content by content creators, providers, or other commercial entities. In various embodiments, the web portal 130 may enable users to establish personal profiles to facilitate storing, creating, modifying, associating, and/or presenting multimedia content. In various embodiments, the web portal 130 may be operatively coupled to the one or more third party sites 140 (for example, via Application Programming Interface (API) codes).

The third party sites 140 may refer to any one or more web pages or websites accessible via the communications network(s) 170. In a specific, non-limiting example, the third party site(s) 140 may include social media sites or various online and software tools that enable people to communicate via the communication network(s) 170 and share information and resources (text, audio, video, images, podcasts, and other multimedia). The social media sites may include social networking sites, blogs, microblogs, podcasts, chats, web feeds, content-sharing tools, and so forth. In various embodiments, the third party sites 140 may include dedicated software applications, scripts, or codes to enable users to access the content association system 110, the content presentation system 120, or the web portal 130. For example, the third party sites 140 may include a widget to enable users to play various content via the third party sites 140.

Through continued reference to FIG. 1, the one or more datastore(s) 150 may include one or more databases for storing multimedia content, a digital library, a digital media store, and so forth. The datastore(s) 150 may enable users, the content association system 110, the content presentation system 120, or the web portal 130 to download, export, or upload various content in any suitable manner.

The user device(s) 160 may include various electronic computing devices having the ability to retrieve, access, receive, and/or present (e.g., display) data. A non-exhaustive list of suitable user device(s) 160 may include a desktop computer, a laptop computer, a tablet computer, a server, a thin client, a personal digital assistant (PDA), a mobile tablet device, a handheld cellular device, a mobile phone, a smart phone, a gaming console, a set-top box, a television set, a smart television set or Internet television set (e.g., a television set having the ability to transmit and receive data over the Internet), and so forth. In various illustrative embodiments, the user device(s) 160 may have a browser (e.g., web browser) installed thereon to enable user(s) of the device(s) to access content or otherwise interact with the web portal 130 and/or the third party sites 140. In various embodiments, the user device(s) 160 may have one or more dedicated software applications installed thereon (e.g., mobile applications or tablet computer applications) to enable the users to create, modify, associate, and/or present multimedia content. In other example embodiments, the dedicated software applications may provide functionality to access and interact with the content association system 110 and/or the content presentation system 120. In yet other embodiments of the disclosure, the dedicated software applications installed on the user device(s) 160, the content association system 110, and/or the content presentation system 120 may each be capable of communicating and interacting via the communication network(s) 170.

Through continued reference to FIG. 1, the communication network(s) 170 may include any combination of one or more public or private wired or wireless networks. Suitable networks may include or interface with any combination of a local intranet, a PAN (personal area network), a LAN (local area network), a WAN (wide area network), a MAN (metropolitan area network), a VPN (virtual private network), a SAN (storage area network), a mesh network, a frame relay connection, an advanced intelligent network (AIN) connection, a synchronous optical network (SONET) connection, a digital T1, T3, E1 or E3 line, a digital data service (DDS) connection, a DSL (digital subscriber line) connection, an Ethernet connection, an ISDN (integrated services digital network) line, a dial-up port such as a V.90, V.34 or V.34b is analog modem connection, a cable modem, an ATM (asynchronous transfer mode) connection, or an FDDI (fiber distributed data interface) or CDDI (copper distributed data interface) connection.

Furthermore, communications may also include links to any of a variety of wireless networks, including WAP (wireless application protocol), GPRS (general packet radio service), GSM (global system for mobile communication), CDMA (code division multiple access) or TDMA (time division multiple access), cellular phone networks, GPS, CDPD (cellular digital packet data), RIM (Research in Motion, Limited) duplex paging network, Bluetooth radio, or an IEEE 802.11-based radio frequency network. The communication network(s) 170 may further include or interface with any one or more of the following: a RS-232 serial connection, an IEEE-1394 (firewire) connection, a fiber channel connection, a IrDA (infrared) port, a SCSI (small computer systems interface) connection, a USB (universal serial bus) connection, or other wired or wireless, digital or analog interfaces or connections.

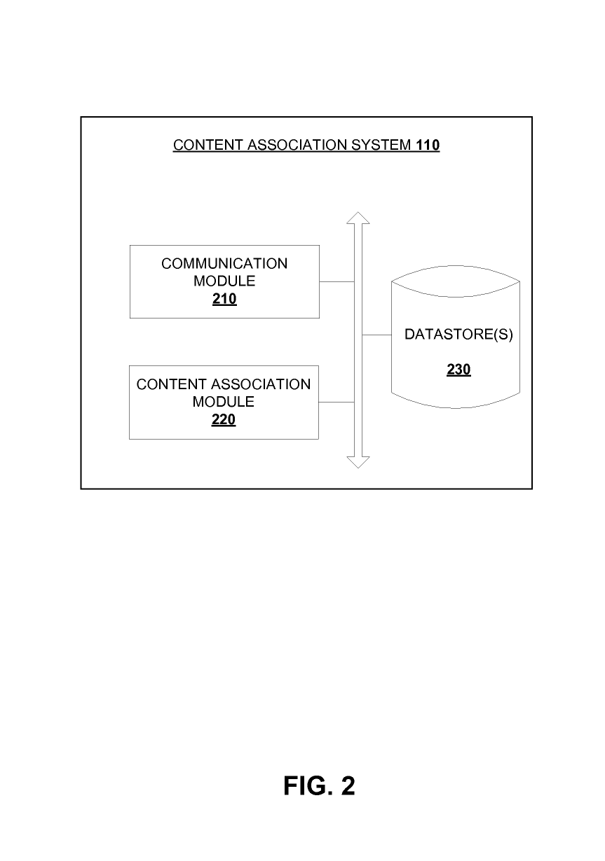

FIG. 2 depicts a simplified block diagram of various illustrative components of the content association system 110. The content association system 110 may include, embed, or be coupled to a communication module 210, a content association module 220, and one or more datastores 230. In general, the content association system 110 may be configured to implement methods disclosed herein for creating, modifying, and/or associating content. In an example embodiment, the content association system 110 may include a dedicated software application which may be installed on the user device(s) 160. Alternatively, the content association system 110 may correspond to a combination of software and/or hardware associated with one or more servers that are accessible by the user device(s) 160 via the communication network(s) 170.

In various embodiments, the communication module 210, the content association module 220, and the datastore(s) 230 may be integrated within a single apparatus or, alternatively, may be accessed remotely via a third party. The content association system 110 may optionally include additional modules beyond those depicted.

The communication module 210 may be configured to interact (e.g., transmit and receive data) with various modules or units such as the user device(s) 160, the web portal 130, the third party site(s) 140, the datastore(s) 150, and so forth. More specifically, the communication module 210 can be configured to import or export content, receive triggering information that includes one or more triggering parameters and one or more associated triggering conditions, receive information relating to content, import or export content association data, and so forth, as will be described below in greater detail.

The content association module 220 may be configured to generate content association data that associates various content based, for example, on received triggering information. For example, the communication module 210 may receive information relating to second content as well as triggering information that specifies the triggering parameters and associated triggering conditions for triggering access to the second content. The content association module 220 may generate content association data that associates the second content with the first content based on the received information. For example, the content association data may include the triggering information and either the second content or a link to the second content. During presentation of the first content, a determination may be made that at least one triggering condition associated with a corresponding triggering parameter is satisfied. The at least one triggering condition may be determined to be satisfied upon the occurrence or establishment of one or more characteristics associated with the first content or presentation of the first content that relates to the corresponding triggering parameter. The second content that is associated with the at least one triggering condition (or the corresponding triggering parameter) may be accessed responsive to the determination that the at least one triggering condition is satisfied. The second content may then be presented to a user (or access thereto may be provided to the user) in association with the first content.

The triggering parameters may include any of the triggering parameters previously described. For example, the triggering parameters may include temporal parameters such as trigger times or trigger time segments, audio characteristics, video characteristics, metadata, audio or video fingerprints, a geographical location associated with the user, and so forth.

In a specific, non-limiting example, the triggering parameter may correspond to a temporal parameter such as a trigger time point or a trigger time segment. The associated triggering condition may be satisfied when a corresponding point in time or segment of time is reached during presentation of the first content. Upon satisfaction of the triggering condition, the second content associated with the triggering parameter may be identified using the content association data, accessed, and presented to a user to whom the first content is being presented. Presentation of the first content may be temporarily halted during presentation of the second content to the user and subsequently resumed. In other embodiments, the first content and the second content may be presented simultaneously. In certain embodiments, the second content may be presented for a duration of the trigger time segment or for some period of time which may be predetermined or determined by attributes of the second content.

In other example embodiments, the triggering parameters may correspond to one or more audio characteristics. For example, the triggering parameters may include voice parameters, and the associated triggering conditions may specify that second content associated with a particular member of a musical group (e.g., images of the group member, links to information concerning the group member, etc.) should be presented when the member's voice occurs during presentation of the first content.

In other example embodiments, the triggering parameters may relate to contextual information associated, for example, with the first content. Associated triggering conditions may specify, for example, that when particular thematic elements associated with the first content being presented to a user occur, associated second content should be accessed and presented to the user. For example, if the first content corresponds to an audio recording that includes lyrics touching upon the theme of war, various images or textual information may be presented in association with specific lyrics. It should be noted that even in those scenarios in which the triggering parameters are not temporal parameters, the triggering conditions may nonetheless correspond to temporal characteristics associated with the presentation of the first content.

In other example embodiments, the triggering parameters may include one or more user interactions with the first content that is being presented to a user. Associated triggering conditions may correspond to the detection of the user interactions. Upon the detection of certain user interactions, corresponding second content associated therewith may be accessed and presented to the user. One of ordinary skill in the art will appreciate that numerous other examples of triggering parameters and associated triggering conditions are within the scope of this disclosure.

The content association data that includes the triggering information and associates the first content with the second content may be integrated into the first content or provided as part of metadata associated with the first content. In various example embodiments, the second content may also be integrated into the first content. Alternatively, the content association data may include data that identifies resources where the first content and/or second content may be stored and/or accessed.

The content association module 220 may be further configured to encrypt and/or compress the content association data, the first content, and/or the second content. In an embodiment, the encryption may be implemented by the Differential Manchester Encoding technique or the like. The content association module 220 may be further configured to identify content to facilitate mechanisms by which users may interact with the content association system 110. For this purpose, digital fingerprinting, watermarking, or audio heuristic analysis may be used.

The datastore(s) 230 may be configured to store various content (e.g., first content and second content, modified or created multimedia content, text, images, video, audio, scripts, codes, and so forth). Further, the datastore(s) 230 may be configured to store triggering information, content association data, settings, and so forth.

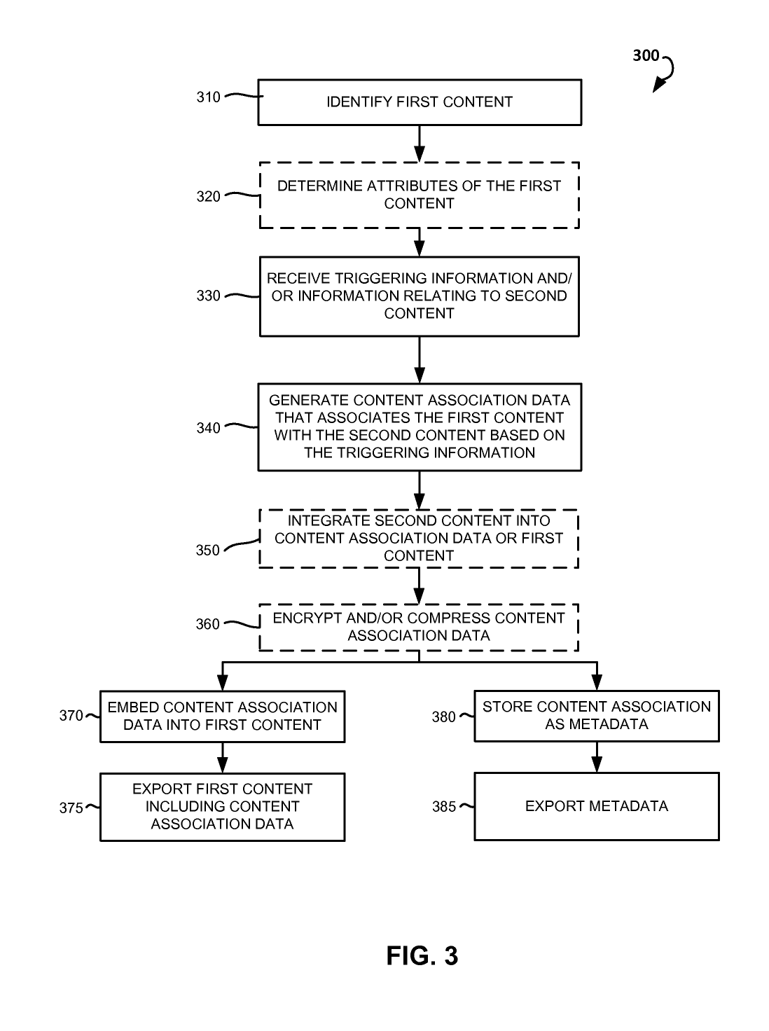

FIG. 3 is a process flow diagram illustrating an example method 300 for associating multimedia content. The method 300 may be performed by processing logic that may comprise hardware (e.g., dedicated logic, programmable logic, and microcode), software (such as software running on a general-purpose computer system or a dedicated machine), or a combination of both. In one example embodiment, the processing logic resides at the content association system 110, which may reside in the user device(s) 160 or in remotely located servers. Each of these modules may comprise processing logic. It will be appreciated by one of ordinary skill in the art that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

As shown in FIG. 3, the method 300 may commence at operation 310 with the communication module 210 identifying the first content such as video or audio content. The first content may be imported or downloaded from the datastore(s) 150 or the datastore(s) 230 based on, for example, a user selection. At optional operation 320, one or more attributes or characteristics of the first content may be determined to facilitate the user interaction experience. Accordingly, an audio or video fingerprint, a watermark, metadata, audio heuristic data, and so forth may be determined.

At operation 330, the content association module 220 may receive (e.g., via the communication module 210) triggering information that specifies one or more triggering parameters and one or more associated triggering conditions. At operation 330, the content association module 220 may also receive information relating to second content which may be used to locate and access the second content. Each of the triggering parameters and associated triggering conditions may be respectively associated with at least a portion of the second content. The second content may include at least one of: an audio content, a video content, an image, text, a web page, content associated with a URI, a script, or a code.

At operation 340, the content association module 220 may generate content association data that associates the first content with the second content. The content association data may include the triggering information that specifies various triggering conditions associated with various triggering parameters and the second content to be accessed upon satisfaction of respective triggering conditions. At operation 350, the content association module 220 may optionally integrate the associated second content into the content association data. Alternatively, the associated second content may optionally be integrated into the first content. At operation 360, the content association module 220 may optionally encrypt and/or compress the content association data. Encryption may prevent illegal copying or regeneration of modified/associated multimedia content.

Further, the content association data may be embedded into the first content (at operation 370) or stored within metadata associated, for example, with the first content (at operation 380). In the first case, the first content with integrated content association data may be exported at operation 375. In the latter case, the metadata may be exported at operation 385. The content association data may in other embodiments be stored remotely from the first content and/or the second content.

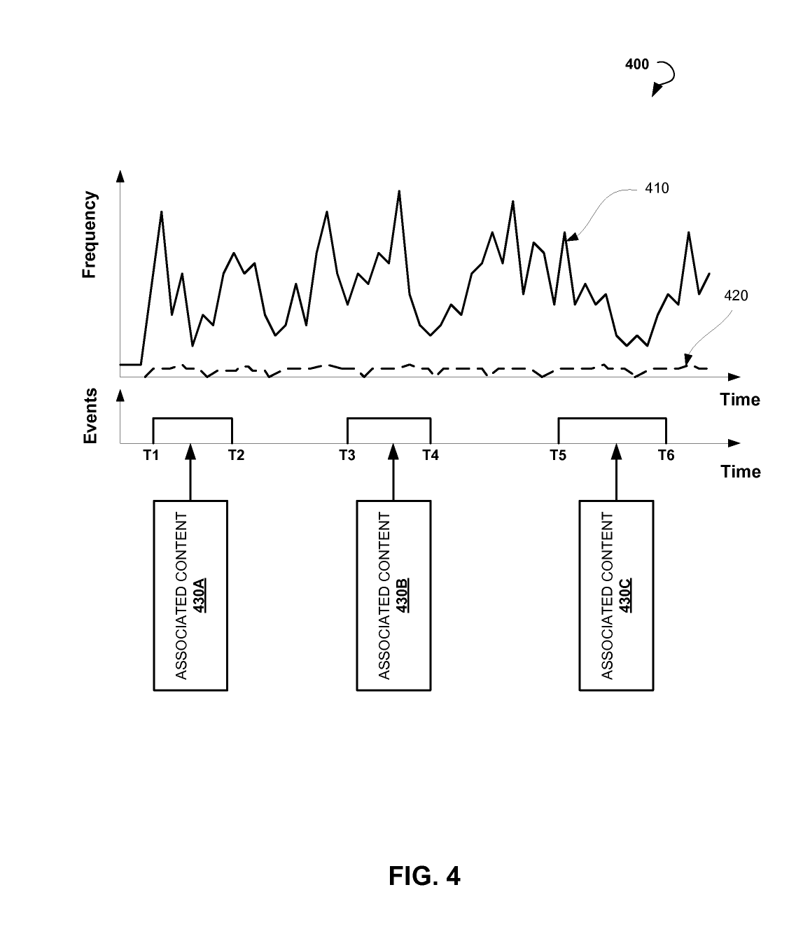

FIG. 4 depicts a simplified representation of various characteristics of an audio recording 400 having multiple trigger time segments associated therewith, according to an example embodiment. In particular, FIG. 4 illustrates a spectrogram (i.e., a simplified two-dimensional diagram of frequency against time). The spectrogram depicts how the overall spectral density 410 of an audio signal varies over time.

Also shown in FIG. 4 is a diagram of events over time. In the example shown, it is given that during the time segment T1 . . . T2, associated content 430A is to be presented to a user. Further, during the time segment T3 . . . T4, associated content 430B is to be presented and, similarly, during the time segment T5 . . . T6, associated content 430C is to be presented. As mentioned, the associated content such as content 430A, 430B, or 430C may be accessed at time points T1, T3, and T5 of the audio recording, which may correspond to triggering conditions associated with triggering parameters specified in the content association data associated with the recording. The associated content 430A, 430B, or 430C may be provided to a user during time segments of the audio recording, the occurrence of which correspond to triggering conditions specified in the content association data. The content association data, which may include the one or more triggering parameters relating to the trigger times and/or trigger time segments, may be provided as part of metadata associated with the recording, or may be integrated into the audio recording. For example, the content association data may be integrated into the audio recording as in-audioable data container 420. One particular implementation of such a data container 420 is an Iterative Dichotomiser 3 (ID3) metadata tag which may be used in conjunction with Moving Picture Experts Group (MPEG) Audio Layer III (MP3) audio files.

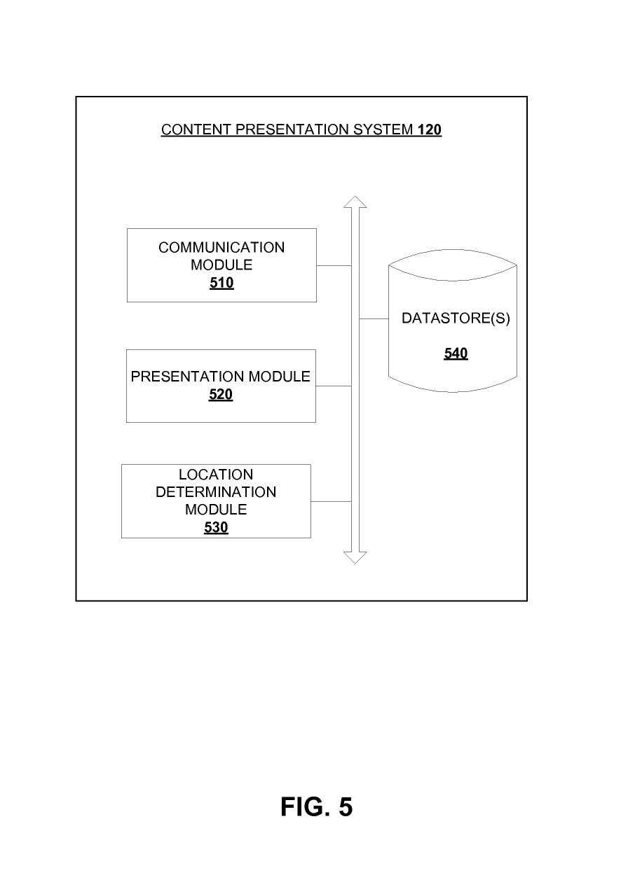

FIG. 5 depicts a simplified block diagram of an illustrative architecture of a content presentation system 120 in accordance with one or more embodiments of the disclosure. The content presentation system 120 may include, embed, or be coupled to a communication module 510, a presentation module 520, a location determination module 530, and/or one or more datastores 540. In general, the content presentation system 120 may be configured to implement methods disclosed herein for presenting multimedia content. In an example embodiment, the content presentation system 120 may be a dedicated software application that may be installed on the user device(s) 160. Alternatively, the content presentation system 120 may be a system installed or associated with one or more servers and may be accessible by the user device(s) 160 via the web portal 130 and/or third party site(s) 140. In various embodiments, the communication module 510, the presentation module 520, the location determination module 530, and/or the datastore(s) 540 may be integrated within a single apparatus or, alternatively, may be remotely located and optionally accessible via a third party. The content presentation system 120 may further include additional modules in various embodiments.

In general, the communication module 510 may be configured to interact (e.g., transmit and receive data) with various modules or units such as the user device(s) 160, input devices (not shown), the web portal 130, the third party site(s) 140, the datastore(s) 150, and so forth. More specifically, the communication module 510 may be configured to receive content association data that associates first content with second content. As previously mentioned, the content association data may include triggering information that specifies one or more triggering parameters and one or more associated triggering conditions. The triggering parameter(s) and associated triggering condition(s) may include any of those previously described. The communication module 510 may be further configured to import the first content and/or the second content from one or more resources such as the datastore(s) 150, the datastore(s) 230, the datastore(s) 540, or the third party site(s) 140.

The presentation module 520 may be configured to present (e.g., display, play, etc.) content to a user via, for example, the user device(s) 160. More specifically, the presentation module 520 may be configured to present the first content to a user, and further present the second content to the user upon the satisfaction of triggering conditions associated with corresponding triggering parameters. For example, in those embodiments in which the triggering parameters include temporal parameters such as trigger time points or trigger time segments, the occurrence of corresponding time points or time segments during presentation of the first content may satisfy triggering conditions associated with the temporal triggering parameters, and may cause the second content to be accessed and presented to the user in association with the first content. Presentation of the first content may be temporarily halted during presentation of the second content and subsequently resumed. Alternatively, the second content may be presented simultaneously with the first content.

In other embodiments, the triggering parameters may include parameters that relate to audio or video characteristics associated with the first content. For example, the triggering parameters may relate to a decibel level of the first content, a brightness level of the first content, and so forth. Associated triggering conditions may specify threshold decibel levels, brightness levels, and so forth, the occurrence of which during presentation of the first content may cause the second content to be accessed and presented.

The triggering parameters may further include parameters that relate to contextual information associated with the first content. For example, the triggering parameters may relate to thematic elements associated with the first content (e.g., thematic elements in lyrics of the first content, particular instruments or voices present in the first content, etc.). Associated triggering conditions may correspond to the occurrence of the contextual information during presentation of the first content, and second content that corresponds to respective contextual elements may be accessed and presented.

The triggering parameters may further include parameters that relate to one or more user interactions with the first content. Upon detecting user input(s) that correspond to the user interaction(s) (e.g., satisfaction of triggering conditions), corresponding second content may be accessed and presented in association with the first content. It should be appreciated that the above examples are merely illustrative of the types of triggering parameters and associated triggering conditions that may be specified and that numerous other triggering parameters and associated triggering conditions are within the scope of the disclosure.

The location determination module 530 may be configured to identify a geographical location associated with a user or a user device 160 used by the user. The location determination module 530 may, for example, acquire location coordinates associated with the user device 160 from a GPS receiver, a cellular network, the Internet, and so forth. According to various embodiments, when the content presentation system 120 is integrated with the user device 160, the location determination module 530 may include a GPS receiver.

The datastore(s) 540 may be configured to store various multimedia content (e.g., first content and second (associated) content, modified multimedia content, etc.). Further, the datastore(s) 540 may be configured to store triggering information including triggering parameters and associated triggering conditions, content association data, user information, settings, and so forth.

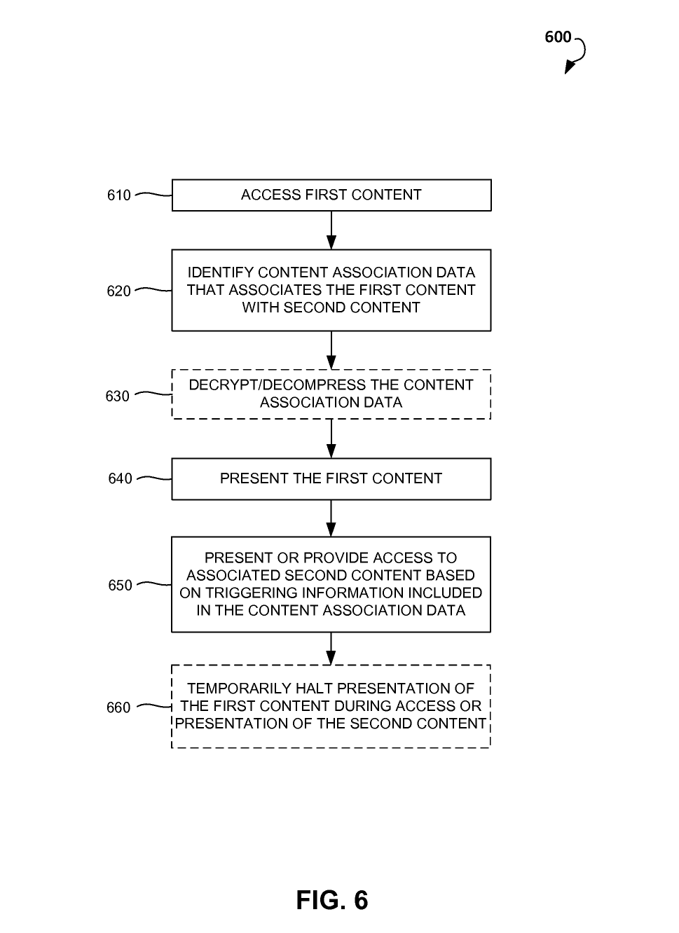

FIG. 6 depicts a process flow diagram illustrating an example method 600 for presenting multimedia content. The method 600 may be performed by processing logic that may comprise hardware (e.g., dedicated logic, programmable logic, and microcode), software (such as software run on a general-purpose computer system or a dedicated machine), or a combination of both. In one example embodiment, the processing logic may reside at the content presentation system 120, which may reside in the user device 160 or in one or more servers accessible via the web portal 130 or the third party site(s) 140. Each of these modules may comprise processing logic. It will be appreciated by one of ordinary skill in the art that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

As shown in FIG. 6, the method 600 may commence at operation 610 with the communication module 510 accessing (importing) first content such as a video or audio content. The first content can be accessed or imported from, for example, the datastore(s) 150.

At operation 620, the communication module 510 may identify or otherwise receive content association data that associates the first content with the second content. As previously mentioned, the content association data may include triggering information that specifies triggering parameters and associated triggering conditions that govern when the second content may be accessed and/or presented. At optional operation 630, the presentation module 520 may decrypt and/or decompress the content association data if the content association data is encrypted or compressed.

At operation 640, the presentation module 520 may present (e.g., play, display, etc.) the first content to a user via a user device 160. At operation 650, as described earlier, the second content may be accessed and presented (or access thereto provided) upon the satisfaction of one or more triggering conditions associated with corresponding triggering parameters. The triggering conditions and associated triggering parameters to which they relate may be specified as part of the triggering information included in the content association data. Satisfaction of the triggering conditions may occur when one or more characteristics associated with the first content or presentation of the first content are present. At optional operation 660, the presentation module 520 may temporarily halt or interrupt the presentation of the first content during access and/or presentation of the second content.

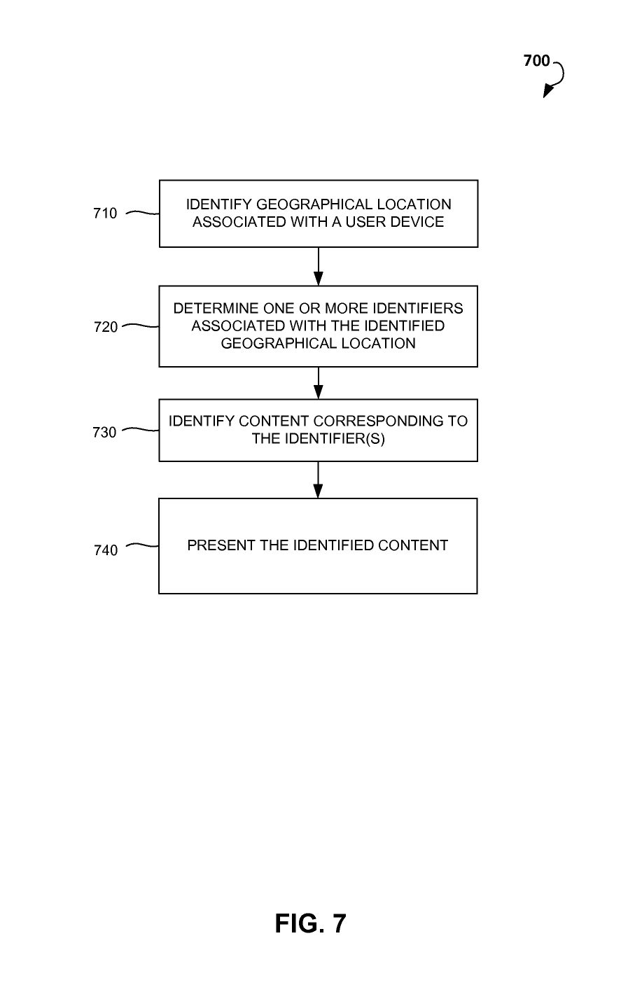

FIG. 7 depicts a process flow diagram illustrating another example method 700 for identifying and presenting content based on a geographical location associated with a user device. The method 700 may be performed by processing logic that may comprise hardware (e.g., dedicated logic, programmable logic, and microcode), software (such as software run on a general-purpose computer system or a dedicated machine), or a combination of both. In one example embodiment, the processing logic may reside at the content presentation system 120, which may reside in the user device 160 or in one or more servers accessible via the web portal 130 or the third party site(s) 140. Each of these modules may comprise processing logic. It will be appreciated by one of ordinary skill in the art that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

As shown in FIG. 7, the method 700 may commence at operation 710 with the location determination module 530 identifying a geographical location associated with a user device 160. The location may be determined by requesting a cellular network to provide location information, or acquiring location coordinates from a GPS receiver, or by receiving location information from the Internet or any other network.

At operation 720, one or more identifiers associated with the identified geographical location may be determined. The one or more identifiers may be determined based on processing logic included in the content association module 220, the presentation module 520, or via any other means. The one or more identifiers may relate to names, historical events, landmarks, and so forth associated with the geographical location. Alternatively, the communication module 510 may receive the one or more identifiers from the user device 160 or from any other source.

At operation 730, content corresponding to the identifier(s) associated with the geographical location may be identified. More specifically, one or more information elements (e.g., metadata tags) may be associated with the content. The content may be identified based on a correspondence between the information element(s) and the identifier(s) associated with the geographical location. Upon identification of the content, the content may be presented, or access to the content may be provided at operation 740. In a specific, non-limiting example, the geographical location may be identified as Seattle, Wash. One or more identifiers (e.g., grunge, alternative rock, etc.) associated with Seattle may be determined or information relating thereto received. Information elements associated with music by various alternative rock bands (e.g., Nirvana, Pearl Jam, etc.) may be determined to correspond to the identifier(s). Based on this determined correspondence, a playlist of songs created by these various bands, historical information about the bands, etc. may be assembled and presented to the user of the user device at operation 740.

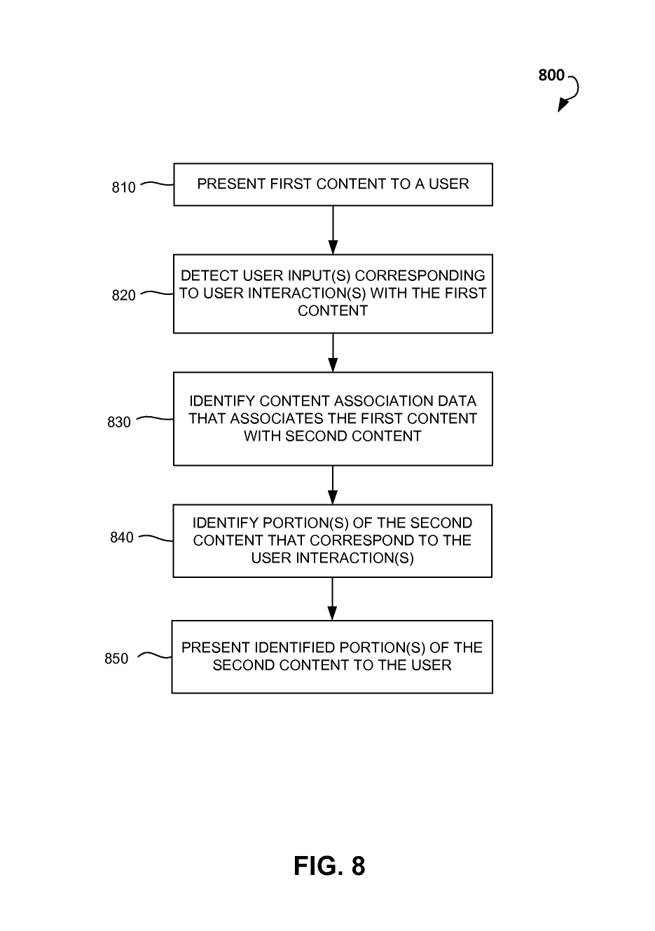

FIG. 8 depicts a process flow diagram illustrating another example method 800 for presenting content based on one or more detected user inputs corresponding to one or more user interactions with other content. The method 800 may be performed by processing logic that may comprise hardware (e.g., dedicated logic, programmable logic, and microcode), software (such as software run on a general-purpose computer system or a dedicated machine), or a combination of both. In one example embodiment, the processing logic may reside at the content presentation system 120, which may reside in the user device 160 or in one or more servers accessible via the web portal 130 or the third party site(s) 140. Each of these modules may comprise processing logic. It will be appreciated by one of ordinary skill in the art that examples of the foregoing modules may be virtual, and instructions said to be executed by a module may, in fact, be retrieved and executed by a processor. The foregoing modules may also include memory cards, servers, and/or computer discs. Although various modules may be configured to perform one or more steps described herein, fewer or more modules may be provided and still fall within the scope of various embodiments.

The method 800 may commence at operation 810 with the presentation module 520 presenting (e.g. playing, displaying, etc.) first content to a user. At operation 820, the communication module 510 may detect or receive information relating to one or more user inputs corresponding to one or more interactions of the user with the user device 160. As a specific, non-limiting example, if the first content includes a clickable image, the user may click on or select part of the image, which may, in turn, generate a corresponding user input.

At operation 830, the communication module 510 may identify or otherwise receive content association data that associates the first content with the second content. The content association data may specify a correspondence between various portions of the second content and respective corresponding user interactions. Accordingly, at operation 840, portion(s) of the second content that correspond to the user interactions associated with the detected user inputs may be identified, and at operation 850, the identified portion(s) of the second content may be presented to the user.

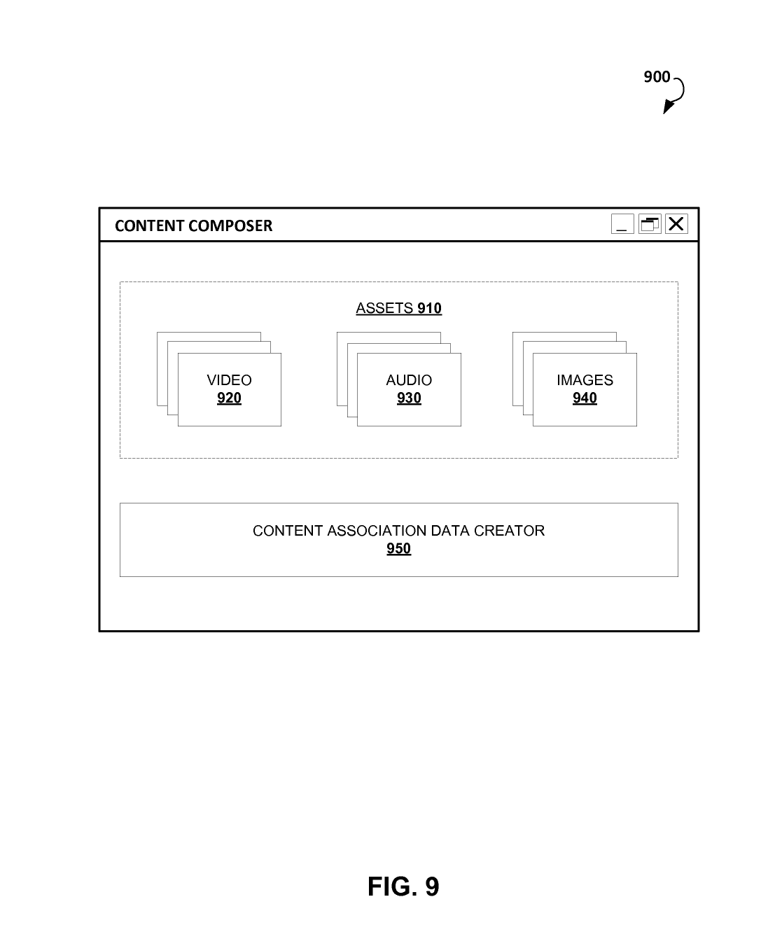

FIG. 9 depicts an example graphical user interface 900 for creating/modifying/associating multimedia content. The graphical user interface 900 may be, for example, displayed or presented on the user device 160. Furthermore, the graphical user interface 900 may be represented as a window (e.g., a browser window). In one example, the graphical user interface 900 may be shown on a display of the user device 160 via a browser or a dedicated software application.

As shown in the figure, the graphical user interface 900 may comprise assets widget 910, which may include, for example, a set of video data 920, a set of audio data 930, and a set of still images 940. This various multimedia content may be stored locally or remotely (e.g., in any of the datastore(s) 150, 230, 540, or the like). In some embodiments, the users may upload their own multimedia content or download it from various remote resources.

The graphical user interface 900 may also include a content association data creator widget 950, which may, in a user-friendly manner, enable users to create, modify, and/or associate multimedia content with other content. In operation, the user may, for example, drag a first content from the assets widget 910 to the content association data creator widget 950. The first content may be, for example, represented in the content association data creator widget 950 as a spectrogram, similar to what is shown in FIG. 4. The user may further drag a second content from the assets widget 910 to the content association data creator widget 950, and specify triggering information including one or more triggering parameters and associated triggering conditions that dictate when and on what conditions that second content may be accessed and/or presented.

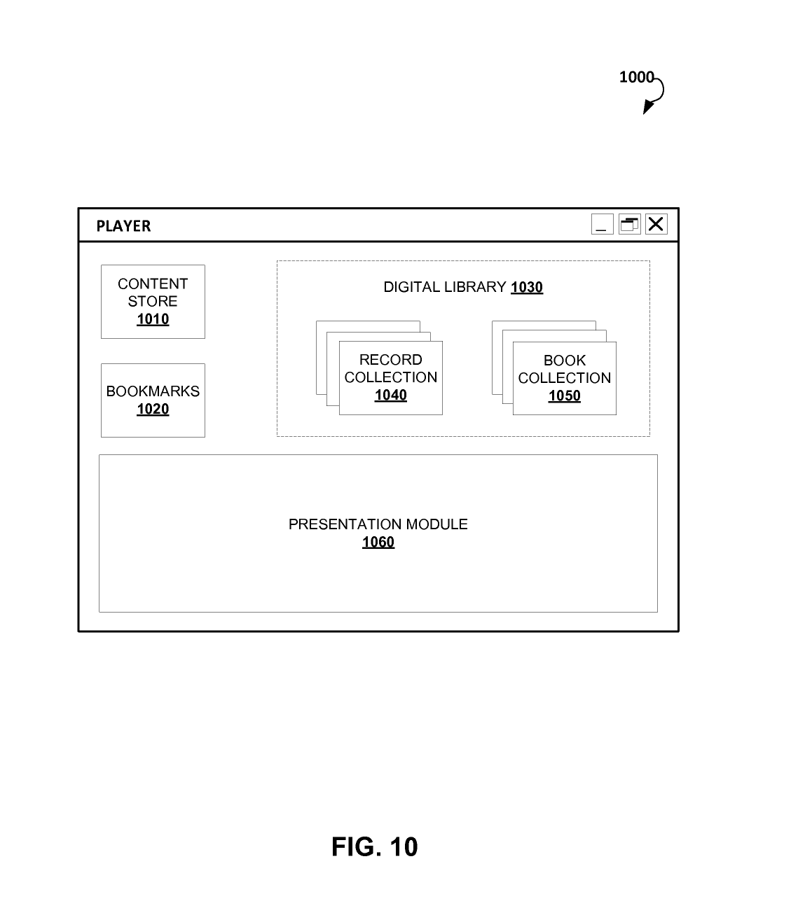

FIG. 10 depicts an example graphical user interface 1000 for presenting multimedia content. The graphical user interface 1000 may be displayed or presented on the user device 160. Furthermore, the graphical user interface 1000 may be represented as a window (e.g., a browser window). In one example, the graphical user interface 1000 may be shown on a display of the user device 160 via a browser or a dedicated software application.

The graphical user interface 1000 may include a content store widget 1010, a bookmarks widget 1020, and a digital library widget 1030 that includes a record collection 1040 and a book collection 1050. The graphical user interface 1000 may further include a presentation module 1060. In general, widgets 1010, 1020, and 1030 provide access to various multimedia content that is stored locally or remotely (e.g., in any of the datastore(s) 150, 230, 540, or the like). The presentation module 1060 may be configured to receive, access, and/or retrieve content association data that associates first content and second content, and analyze the content association data to access and/or present associated second content to a user during the presentation of the first content based on triggering information included in the content association data. The second content may be presented within the same presentation module 1060 or, alternatively, via a pop-up window or another interface widget.

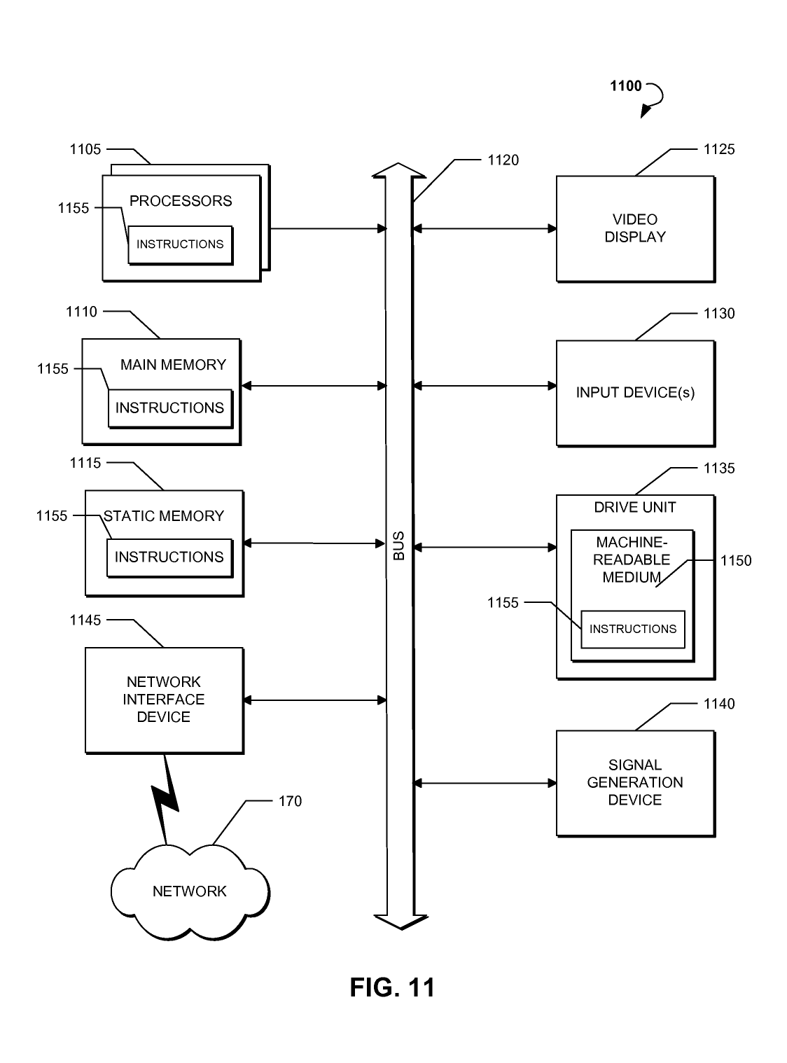

FIG. 11 depicts a diagrammatic representation of a machine in the illustrative form of a computer system 1100, within which a set of stored instructions may be executed to cause the machine to perform any one or more of the methodologies discussed herein. In various example embodiments, the machine may operate as a standalone device or may be connected (e.g., networked) to other machines. In a networked deployment, the machine may operate as a server, a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device, such as an MP3 player), a web appliance, a network router, a switch, a bridge, or any machine capable of executing a set of instructions (sequential or otherwise) that specify actions to be taken by that machine. Further, while only a single machine is illustrated, the term “machine” may also be taken to include any collection of machines that individually or jointly execute a set (or multiple sets) of instructions to perform any one or more of the methodologies discussed herein.

The example computer system 1100 may include a processor or multiple processors 1105 (e.g., a central processing unit (CPU), a graphics processing unit (GPU), or both), and a main memory 1110 and a static memory 1115, which may communicate with each other via a bus 1120. The computer system 1100 may further include a video display unit 1125 (e.g., an LCD or a cathode ray tube (CRT)). The computer system 1100 may also include at least one input device 1130, such as an alphanumeric input device (e.g., a keyboard), a cursor control device (e.g., a mouse), a microphone, a digital camera, a video camera, and so forth. The computer system 1100 may also include a disk drive unit 1135, a signal generation device 1140 (e.g., a speaker), and a network interface device 1145.

The disk drive unit 1135 may include a machine-readable medium 1150, which may store one or more sets of instructions and data structures (e.g., instructions 1155) embodying or utilized by any one or more of the methodologies or functions described herein. The instructions 1155 may reside, completely or at least partially, within the main memory 1110 and/or within the processors 1105 during execution thereof by the computer system 1100. The main memory 1110 and the processors 1105 may constitute machine-readable media.

The instructions 1155 may further be transmitted or received over the network 170 via the network interface device 1145 utilizing any one of a number of well-known transfer protocols (e.g., Hyper Text Transfer Protocol (HTTP), CAN, Serial, and Modbus).

While the machine-readable medium 1150 is shown in an example embodiment to be a single medium, the term “machine-readable medium” includes a single medium or multiple media (e.g., a centralized or distributed database, and/or associated caches and servers) that store the one or more sets of instructions. The machine-readable medium 1150 may include any type of computer-readable storage media including, but not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store desired information and which can be accessed by any of the computing devices disclosed herein. Combinations of any of the above should also be included within the scope of computer-readable storage media. It should be appreciated that the terms “machine-readable medium” and “computer-readable medium” may be used interchangeably herein.

Alternatively, computer-readable media may include computer-readable communication media that includes a data signal, such as a carrier wave, or other transmission media, for storing and transmitting computer-readable instructions, program modules, or other data. As used herein, computer-readable storage media does not include computer-readable communication media.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and may interface with a variety of operating systems. Although not limited thereto, computer software programs for implementing the present method may be written in any number of suitable programming languages such as, for example, Hypertext Markup Language (HTML), Dynamic HTML, Extensible Markup Language (XML), Extensible Stylesheet Language (XSL), Document Style Semantics and Specification Language (DS S SL), Cascading Style Sheets (CS S), Synchronized Multimedia Integration Language (SMIL), Wireless Markup Language (WML), Java™, Jini™, C, C++, C#, .NET, Perl, UNIX Shell, Visual Basic or Visual Basic Script, Virtual Reality Markup Language (VRML), ColdFusion™ or other compilers, assemblers, interpreters, or other computer languages or platforms.

Although embodiments of the disclosure have been described with reference to specific example embodiments, it will be evident to one of ordinary skill in the art that various modifications and changes may be made to these example embodiments without departing from the broader spirit and scope of the disclosure. Accordingly, the specification and drawings are to be regarded in an illustrative rather than a restrictive sense.

What is claimed is:

1. A method, comprising:
identifying, by one or more computers comprising one or more processors, first content;
receiving, by the one or more computers, triggering information identifying one or more triggering parameters and one or more triggering conditions associated with the one or more triggering parameters;
associating, by the one or more computers, the triggering information with the first content;
receiving, by the one or more computers, information identifying second content; and
associating, by the one or more computers, the second content with the first content based at least in part on at least a portion of the triggering information.

2. The method of claim 1, wherein the first content comprises at least one of: audio content or video content, and wherein the second content comprises at least one of: audio content, video content, an image, text, a web page, a script, or a code.

3. The method of claim 1, wherein the one or more triggering parameters comprise at least one of:
i) one or more temporal parameters,
ii) one or more attributes associated with content different from the first content or the second content,
iii) contextual information,
iv) one or more attributes associated with a user device,
v) one or more audible elements, one or more video elements, or one or more frequency elements associated with at least one of: the first content or presentation of the first content,
vi) user input received by the user device,
vii) an interaction between a user and the first content or the second content,
viii) a geographical location associated with the user, or
ix) a geographical location associated with the user device.

4. The method of claim 3, wherein the one or more temporal parameters comprise at least one of: a trigger time point or a trigger time segment.

5. The method of claim 1, wherein the one or more triggering parameters comprise metadata associated with the first content, and wherein the metadata comprises at least one of: a track listing, a song title, an album title, a track number, one or more tags associated with the first content, an audio fingerprint, or a video fingerprint.

6. The method of claim 1, wherein associating the triggering information with the first content and associating the second content with the first content comprises:
generating, by the one or more computers, content association data based at least in part on the triggering information; and
associating, by the one or more computers, the content association data with the first content and the second content.

7. The method of claim 6, wherein associating the content association data with the first content comprises integrating, by the one or more computers, the content association data with the first content.

8. The method of claim 7, further comprising:
transmitting, by the one or more computers, the first content integrated with the content association data to a user device for presentation to a user;
receiving, by the one or more computers from the user device, an indication that a triggering condition of the one or more triggering conditions is satisfied;
accessing, by the one or more computers and responsive to receiving the indication, the second content based at least in part on the information identifying the second content; and
transmitting, by the one or more computers, the second content to the user device for presentation to the user.

9. The method of claim 7, further comprising:
identifying, by the one or more computers, a link to the second content from the information identifying the second content;
transmitting, by the one or more computers, the first content integrated with the content association data to a user device for presentation to a user, wherein the content association data comprises the link to the second content.

10. The method of claim 6, further comprising:
transmitting, by the one or more computers, the first content to a user device for presentation to a user;
determining, by the one or more computers, that a triggering condition of the one or more triggering conditions is satisfied;
accessing, by the one or more computers and responsive to determining that the triggering condition is satisfied, the second content based at least in part on the information identifying the second content; and
transmitting, by the one or more computers, the second content to the user device for presentation to the user.

11. A system, comprising:
at least one processor; and
at least one memory storing computer-executable instructions,
wherein the at least one processor is configured to access the at least one memory and execute the computer-executable instructions to:
identify first content,
receive triggering information identifying one or more triggering parameters and one or more triggering conditions associated with the one or more triggering parameters;
associate the triggering information with the first content;
receive information identifying second content, and
associate the second content with the first content based at least in part on at least a portion of the triggering information.

12. The system of claim 11, wherein, to associate the triggering information with the first content and to associate the second content with the first content, the at least one processor is configured to execute the computer-executable instructions to:
generate content association data based at least in part on the triggering information; and
associate the first content and the second content with the content association data.

13. The system of claim 12, wherein the at least one processor is further configured to execute the computer-executable instructions to: transmit the first content to a user device for presentation to a user; transmit the content association data to the user device;
receive an indication that a triggering condition of the one or more triggering conditions is satisfied;
access the second content responsive to receiving the indication and based at least in part on the information identifying the second content; and
transmit the second content to the user device for presentation to the user.

14. One or more computer-readable media storing computer-executable instructions that responsive to execution cause operations to be performed comprising:
identifying first content;
identifying triggering information comprising one or more triggering parameters and one or more triggering conditions associated with the one or more triggering parameters;
receiving information identifying second content; and
generating content association data based at least in part on the triggering information, wherein the content association data associates the second content with the first content.

15. The one or more computer-readable media of claim 14, the operations further comprising:
transmitting the first content to a user device for presentation to a user;
transmitting the content association data to the user device;
receiving, from the user device, an indication that a triggering condition of the one or more triggering conditions is satisfied;
identifying the second content based at least in part on the content association data;
accessing the second content based at least in part on the information identifying the second content; and
transmitting the second content to the user device for presentation to the user.

16. The one or more computer-readable media of claim 14, the operations further comprising:
transmitting the first content to a user device for presentation to a user; determining that a triggering condition of the one or more triggering conditions is satisfied;
identifying the second content based at least in part on the content association data;
accessing the second content based at least in part on the information identifying the second content; and
transmitting the second content to the user device for presentation to the user.

17. The one or more computer-readable media of claim 16, the operations further comprising:
temporarily causing, by the one or more computers, the presentation of the first content to be halted during the presentation of the second content; and
causing, by the one or more computers, the presentation of the first content to be resumed subsequent to or during the presentation of the second content.

18. The one or more computer-readable media of claim 14, wherein the content association data is stored as at least a portion of metadata associated with the first content.

19. A method, comprising:
identifying, by one or more computers comprising one or more processors, a geographical location associated with a user device;
determining, by the one or more computers, one or more identifiers associated with the geographical location; and
identifying, by the one or more computers, content based at least in part on at least one of the one or more identifiers associated with the geographical location.

20. The method of claim 19, wherein identifying the content comprises:
determining, by the one or more computers, that one or more information elements associated with the content correspond to the at least one of the one or more identifiers associated with the geographical location.

21. The method of claim 19, further comprising:
transmitting, by the one or more computers, the content for presentation to a user.

22. A system, comprising:
at least one processor; and
at least one memory storing computer-executable instructions,
wherein the at least one processor is configured to access the at least one memory and execute the computer-executable instructions to:
identify a geographical location associated with a user device;
determine one or more identifiers associated with the geographical location; and
identify content based at least in part on at least one of the one or more identifiers associated with the geographical location.

23. The system of claim 22, wherein, to identify the geographical location associated with the user device, the at least one processor is further configured to execute the computer-executable instructions to:
receive an indication of the geographical location from the user device.

24. The system of claim 22, wherein, to identify the content, the at least one processor is configured to execute the computer-executable instructions to:
determine one or more information elements associated with the content; and
determine that at least one of the one or more information elements corresponds to the at least one of the one or more identifiers associated with the geographical location.

25. A method, comprising:
transmitting, by one or more computers comprising one or more processors, first content for presentation to a user;
receiving, by the one or more computers, one or more inputs corresponding to one or more user interactions of the user with the first content;
identifying, by the one or more computers, second content associated with the first content based at least in part on the one or more user interactions;
accessing, by the one or more computers, the second content; and
transmitting, by the one or more computers, the second content for presentation to the user.

26. The method of claim 25, wherein each of the first content and the second content comprises a respective at least one of: audio content, video content, an image, text, a web page, a script, or a code.

27. The method of claim 25, wherein identifying the second content comprises:
identifying, by the one or more computers, content association data that associates the second content with the first content, wherein the content association data comprises triggering information comprising one or more triggering parameters and one or more triggering conditions associated with the one or more triggering parameters, and
determining, by the one or more computers, that the one or more user interactions satisfy at least one triggering condition of the one or more triggering conditions, wherein the at least one triggering condition is associated with a corresponding at least one triggering parameter of the one or more triggering parameters.
